(19) United States
(12) Patent Application Publication
(10) Pub. No.: US 2008/0093037 A1
(43) Pub. Date: Apr. 24, 2008

(54) Door Provided With a Curtain Which is Raisable by Winding and Has an Improved Lateral Tightness

(76) Inventor: Bernard Kraeutler, Dunieres (FR)

Correspondence Address: CANTOR COLBURN, LLP, 20 Church Street, 22nd Floor, Hartford, CT, 06103, US

(21) Appl. No.: 10/582,466

(22) PCT Filed: Dec. 10, 2004
(86) PCT No.: PCT/FR04/03189

§ 371 Date: Aug. 20, 2007

(51) Int. Cl. E06B 9/17

(52) U.S. Cl. 160/271

(57) ABSTRACT

The inventive door comprises two lateral posts each of which is provided with a slide (9) bounded by two wings (8), a transversal element connecting the top ends of the lateral posts, a flexible curtain (5) whose lateral edges are inserted into the slides (9) and means for winding said curtain (5) in the open door position. According to said invention, each slide (9) is provided with a sealing profile (7) comprising a bottom wall (10) and two lateral walls (11) which substentially form an U-shape. Each lateral wall (11) rests against the wing (8) adjacent thereto.

The present invention relates to a seal and to a door which is provided with a curtain which is raisable by winding, having improved lateral tightness.

Certain industrial activities, for example in the pharmaceutical, agri-food and electronics sectors, must be carried out in rooms with a controlled atmosphere whose quality has a direct influence on the quality of the products or of the operations taking place therein. These rooms are generally at superatmospheric pressure to prevent contaminants from entering inside said rooms.

It is of course necessary to gain access to these rooms by means of openings or bays which are closed by means of doors.

These doors may be doors provided with a flexible curtain which is raisable by winding, the major advantage of these doors being their ability to open and close very quickly.

The quick-acting ability of these doors proves to be extremely beneficial insofar as they enable the time during which they are open to be minimized.

A problem which these doors have been unable to solve in a completely satisfactory manner, however, is that of their lateral tightness when they are in the closed position.

To be precise, it is frequently observed in rooms maintained at superatmospheric pressure for a leakage flow to occur at the lateral edges of the curtain.

It has certainly been considered to equip the lateral edges of the curtain directly with sealing elements which rub against lateral slideways of the door, as can be shown from document EP 623 731.

A significant drawback of this manner of sealing provision stems from the fact that when the operations of winding and unwinding the curtain are taking place, the sealing elements rub against the slideways and end up becoming worn.

The consequences of this are doubly detrimental.

Firstly, the worn sealing elements no longer performing their function have to be replaced. Now, given that these are generally welded to the lateral edges of the curtain, it is required to detach the curtain from the door, place it on the ground, remove the welds from the worn lateral sealing elements, reweld new lateral sealing elements and then refit the curtain on a winding shaft belonging to the door. All these operations are therefore long and thus make the room inoperative, since, on account of these operations, the curtain has been detached and does not provide any closure function.

Secondly, the rubbing of the sealing elements against the door posts produces particles which contaminate the room whose access is controlled by the door.

The invention aims to solve the many drawbacks of the prior art and more specifically aims to provide lateral sealing for a door provided with a curtain which is raisable by winding, this sealing guaranteeing a low leakage rate while at the same time being easy to install and replace.

In a manner known per se, the door comprises:
two lateral posts each having a slideway bounded by two wings,
a transverse element connecting the upper ends of the lateral posts,
a flexible curtain having lateral edges engaging in each of the slideways, and
means for winding the curtain into a door-opening position.

According to the invention, each of the slideways is equipped with a sealing profile having a back wall and two lateral walls substantially forming a U, each of the lateral walls bearing against the wing which is adjacent to it.

To complete the sealing and prevent the accumulation of organic or mineral contaminants, each lateral wall of the sealing profile is dimensioned such that it bears against the wing of the slideway which is adjacent to it.

Advantageously, each of the lateral walls is provided with at least one lip which is able to come into contact with a lateral edge of the curtain.

According to an advantageous feature of the door, the curtain has a continuous flattened lateral edge obtained by high-frequency welding. This arrangement makes it possible to create a linear contact between the curtain and the sealing profile.

Preferably, each of the lateral walls and each lip are tapered at their ends so as to be very flexible.

According to one embodiment, in the region of the upper end of each post, a guide head has a U-shaped cross section comprising a back wall and two lateral walls, each lateral wall being provided with a guide rib, the guide head being positioned in the continuation of each sealing profile.

To provide a clear understanding of the invention, the latter is described with reference to the appended drawing representing, by way of non-limiting example, an embodiment of a door according to the invention.

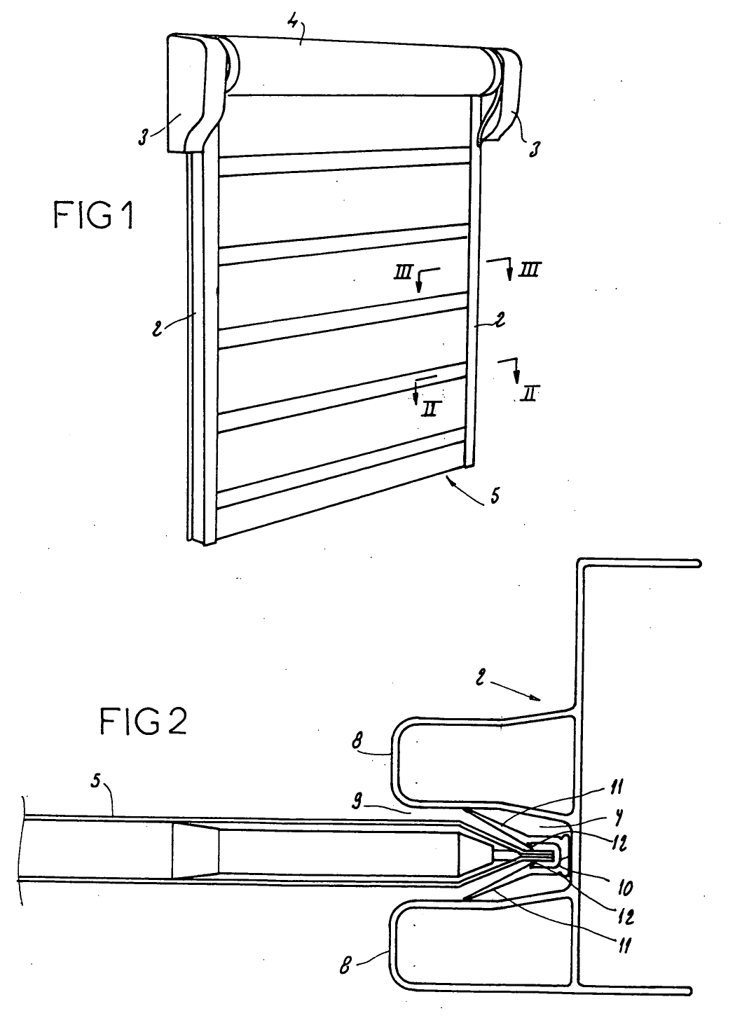

FIG. 1 represents a door in perspective,

FIG. 2 is a view in section taken along II-II of FIG. 1,

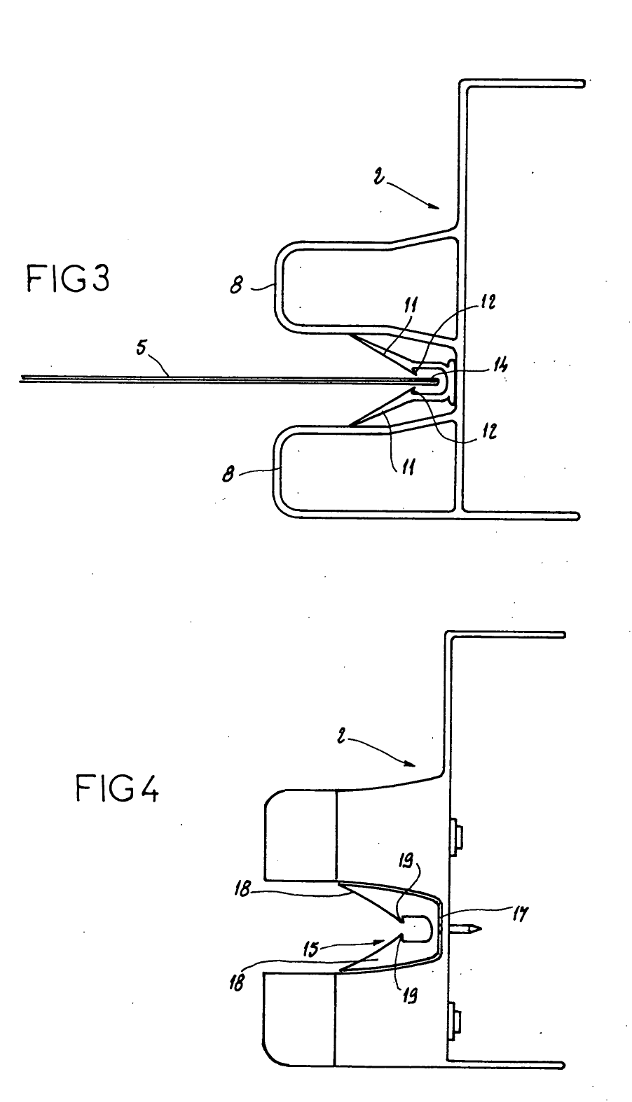

FIG. 3 is a view in section taken along III-III of FIG. 1,

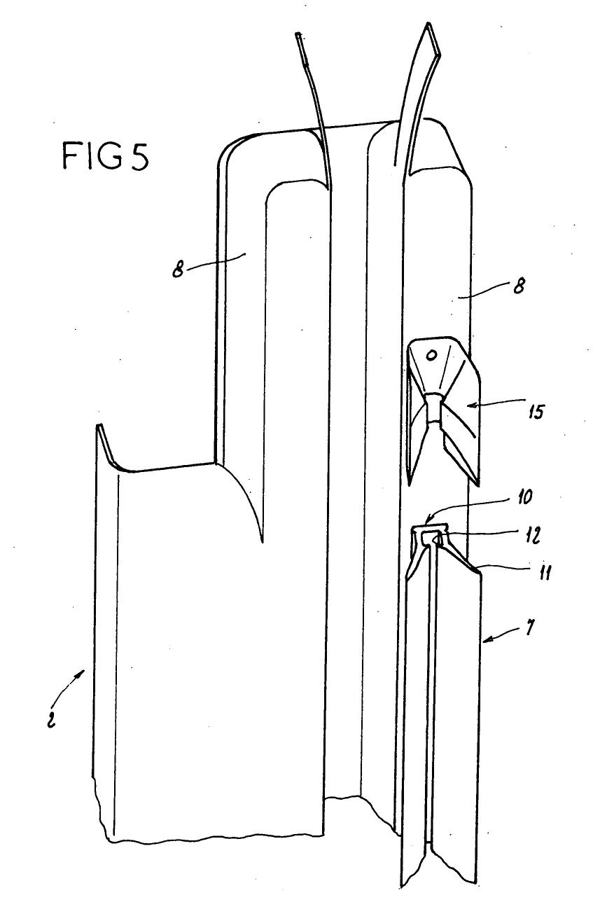

FIG. 4 is a plan view of the post, and

FIG. 5 is an exploded perspective view of the upper part of a door post.

With reference first of all to FIG. 1, it can be seen that the door has two lateral posts 2 which border an opening made in a partition wall. A bracket 3 is placed a the upper end of each post. These two brackets 3 support a shaft which, in the example represented, is concealed by a transverse housing 4.

A curtain 5 is secured to the shaft. The curtain 5 consists of butt-welded horizontal strips of flexible material.

It will also be observed that the curtain 5 has stiffening bars 6.

As can be seen from FIG. 2, which shows a post 2 in cross section, this post is provided on its face directed toward the curtain 5 with two wings 8 bounding a slideway 9 between them. Depending on the particular case, the wings 8 bounding the slideway may form integral parts of the posts 2, for example in the case of extruded posts as can be seen from the drawing. In other embodiments, these wings may also be added as separate items to the posts 2.

Each lateral edge of the curtain 5 is inserted into the slideway 9 which is adjacent to it.

The essential feature of the door according to the invention is that a sealing profile 7 is placed in the back of each slideway 9.

The sealing profile 7 has a back wall 10 and two lateral walls 11 forming a U. Each lateral wall 11 bears against the wing 8 which is adjacent to it.

It will also be observed that the mutually facing faces of each of the lateral walls 11 are provided with a lip 12.

As can be seen from FIG. 2, each lip 12 as well as the ends of each of the lateral walls 11 are tapered so as to be very flexible.

The sealing profile 7 is secured to the interior of the slideway 9 by adhesively bonding its back wall 10 against the back wall of the slideway 9.

With regard to the curtain 5, a particular feature thereof is that it has a continuous flattened lateral edge 14 formed by high-frequency welding.

FIG. 4 shows the upper part of the door posts 2. It can be seen from this figure that a guide head 15 is placed in the slideway 9 in the continuation of the sealing profile 7.

The guide head 15 is a molded plastic element having a U-shaped cross section comprising a back wall 17 and two lateral walls 18.

FIG. 5 shows that, moreover, each lateral wall 11 of the head is equipped with a rib 19.

The door operates in a conventional manner, that is to say by winding the curtain 5 around the shaft to allow passage through the door and by unwinding the curtain 5 to obtain closure of the door.

Where the door provides access to a space which is at superatmospheric pressure, this door, when in the closed position, is subjected to a pressure over the whole of the surface of its curtain 5.

The lateral edges of the curtain 5 then press, under the effect of the pressure, against one of the lips 12 of the sealing profile 7 depending on which face of the curtain 5 is subjected to a superatmospheric pressure. In the upper part of the posts 2, the edges of the curtain 5 bear against the ribs of the guide head 15.

A very low leakage rate via the lateral edges of the curtain 5 is then observed. The sealing created by the profile is thus essentially static.

When winding up the curtain 5, the latter is no longer subjected to any kind of pressure by virtue of the massive leakage flow occurring in the region of the sill bar of the curtain 5. The lateral edges of the curtain 5 are therefore no longer bearing against the lips 12. Thus, minimum rubbing occurs between the curtain 5 and the sealing profile 7, the resulting advantage being that the profile has a very long service life and there is less debris formation due to friction.

Nevertheless, the profile is subject to wear. When it no longer performs its functions, the profile can be replaced extremely easily since all that is required is to raise the curtain 5, detach the worn profile and then refit a new profile into the slideways 9. This operation may take place in a very short time period and by maintenance personnel who do not have any specific qualification.

Of course, the invention is not limited to the embodiment described above by way of example, but rather encompasses all the embodiments thereof.

1. A door comprising:
two lateral posts each having a slideway bounded by two wings,
a transverse element connecting upper ends of the lateral posts,
a flexible curtain having lateral edges engaging in each of the slideways, and
means for winding the curtain into a door-opening position, wherein each of the slideways is equipped with a sealing profile having a back wall and two lateral walls substantially forming a U-shape, each of the lateral walls bearing against the wing which is adjacent to it.

2. The door as claimed in claim 1, wherein each of the lateral walls is provided with at least one lip which is able to come into contact with a lateral edge of the curtain.

3. The door as claimed in claim 1, wherein each lateral wall of the sealing profile is dimensioned to bear against the wing of the slideway which is adjacent to it.

4. The door as claimed in claim 1, wherein the curtain has a continuous lateral edge flattened by high-frequency welding.

5. The door as claimed in claim 2, wherein each of the lateral walls and each lip are tapered at their ends.

6. The door as claimed in claim 1, wherein in a region of the upper end of each post, a guide head has a U-shaped cross section comprising a back wall and two lateral walls, each lateral wall being provided with a guide rib, the guide head being positioned in a continuation of each sealing profile.
